(19) United States
(12) Patent Application Publication
(10) Pub. No.: US 2007/0230187 A1
(43) Pub. Date: Oct. 4, 2007

(54) LIGHT SOURCE AND INSTRUMENTS INCLUDING SAME

(76) Inventors: Thomas J. Boes, Grandville, MI (US); John Calow, Plainwell, MI (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/695,935

(22) Filed: Apr. 3, 2007

Related U.S. Application Data
(60) Provisional application No. 60/788,900, filed on Apr. 3, 2006.

(51) Int. Cl. F21V 29/00

(52) U.S. Cl. 362/294

(57) ABSTRACT

A light source. The light source may comprise a substrate comprising at least one flexible portion; an illumination source mounted on the flexible portion; and a structural unit positioned relative to the flexible portion to determine a deflection angle of the flexible portion. An illumination angle of the light source may be dependent on the deflection angle of the flexible portion. Instruments including the light source are also disclosed, along with a method of changing the illumination angle of the light source. The method may comprise the steps of removing the structural unit and replacing the structural unit with a second structural unit positioned relative to the flexible portion to deflect the flexible portion by a second deflection angle.

### CROSS-REFERENCE TO RELATED APPLICATIONS

This application claims the benefit of U.S. Provisional Application Ser. No. 60/788,900 filed on Apr. 3, 2006.

### BACKGROUND

Optical instruments such as calorimeters, densitometers, dot meters, gloss meters, and the like typically include an integral light source for illuminating a specimen and one or more sensors for receiving light reflected from or transmitted through the specimen. Characteristics of the specimen (e.g., color, transmittance, reflectance, etc.) may then be determined by measuring and analyzing properties of the received light. An accurate determination of such characteristics generally requires that light emitted from the light source strike the specimen at a pre-determined illumination angle(s). Colorimeters and densitometers, for example, may require a 45°/0° illuminator/sensor geometry, whereas gloss meters may require a number of different illuminator/sensor geometries depending upon surface characteristics of the particular specimen.

During instrument development and testing, it is frequently necessary to alter the illumination angle(s) of the emitted light for, among other things, determining the operating charactertics and optimal configuration of the instrument. Performing such adjustments using conventional light source designs may be inconvenient and require expensive and/or time-consuming modifications of the light source. Furthermore, conventional light sources are typically customized to their respective instruments and are not easily adapted for use in other instruments having different illumination angle requirements. Therefore, for manufacturers having different lines of instruments, the inability to easily adapt a light source for use in different instruments may result in relatively high design and manufacturing costs.

Accordingly, there exists a need for a light source for use in the above-identified instruments, as well for use in other instruments and illumination applications, that enables the illumination angle(s) of emitted light to be quickly and easily adjusted.

### SUMMARY

In one aspect, the present invention is directed to a light source. The light source may comprise a substrate comprising at least one flexible portion; an illumination source mounted on the flexible portion; and a structural unit positioned relative to the flexible portion to determine a deflection angle of the flexible portion. An illumination angle of the light source may be dependent on the deflection angle of the flexible portion. Instruments including the light source are also disclosed, along with a method of changing the illumination angle of the light source. The method may comprise the steps of removing the structural unit and replacing the structural unit with a second structural unit positioned relative to the flexible portion to deflect the flexible portion by a second deflection angle.

In another aspect, the present invention is directed to another light source. This light source may comprise a substrate comprising at least one flexible portion; an illumination source mounted to the flexible portion; a holder positioned in an illumination path of the illumination source; and a backer. The at least one flexible portion may be positioned between the backer and the holder. Also, a deflection angle of the flexible portion may be determined by a taper angle of at least one of the backer and the holder.

### DESCRIPTION OF THE FIGURES

FIG. 1 illustrates an exploded view of an instrument according to various embodiments;

FIGS. 2 illustrates a top view of various embodiments of the holder of the instrument of FIG. 1;

FIG. 3 illustrates various embodiments of the backer of the instrument of FIG. 1;

FIG. 4 illustrates various embodiments of the flexible substrate of the instrument of FIG. 1;

FIG. 5 illustrates various embodiments of the chassis of the instrument of FIG. 1;

FIG. 6 illustrates the backer of FIG. 3 attached to the chassis of FIG. 5;

FIG. 7 illustrates a bottom view of the chassis having the backer, the flexible substrate, and the holder installed thereon according to various embodiments; and

FIG. 8 illustrates the dependence of the illumination angle upon the deflection of the flexible portions of the flexible substrate according to various embodiments.

### DESCRIPTION

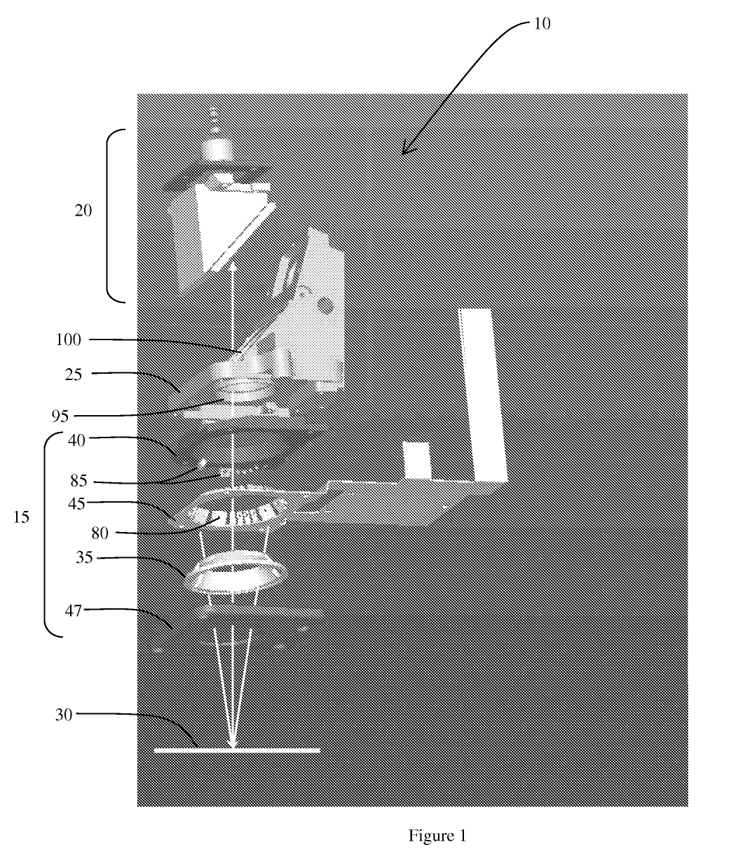

FIG. 1 illustrates an exploded view of an instrument 10 according to various embodiments of the present invention. The instrument 10 may generally be any instrument configured for illuminating a specimen 30 and may also analyze the reflected light (or light transmitted through the specimen 30) to determine one or more of optical characteristics of the specimen 30. Such instruments may include, for example, spectrophotometers, calorimeters, densitometers, gloss meters, dot meters, etc. In the illustrated embodiments, the instrument 10 is configured for analyzing reflected light. According to various embodiments, the instrument 10 comprises a light source 15 and a light sensor assembly 20 mounted to a chassis 25. In use, light generated by the light source 15 is emitted from the instrument 10 and illuminates the specimen 30. A portion of the emitted light that is reflected from the specimen 30 may be received through apertures of the light source 15 and chassis 25 and directed to the light sensor assembly 20. Signals generated by the light sensor assembly 20 responsive to the reflected light may be processed to determine characteristics of the specimen 30. Signal processing may be conducted using processing means internal or external to the instrument 10.

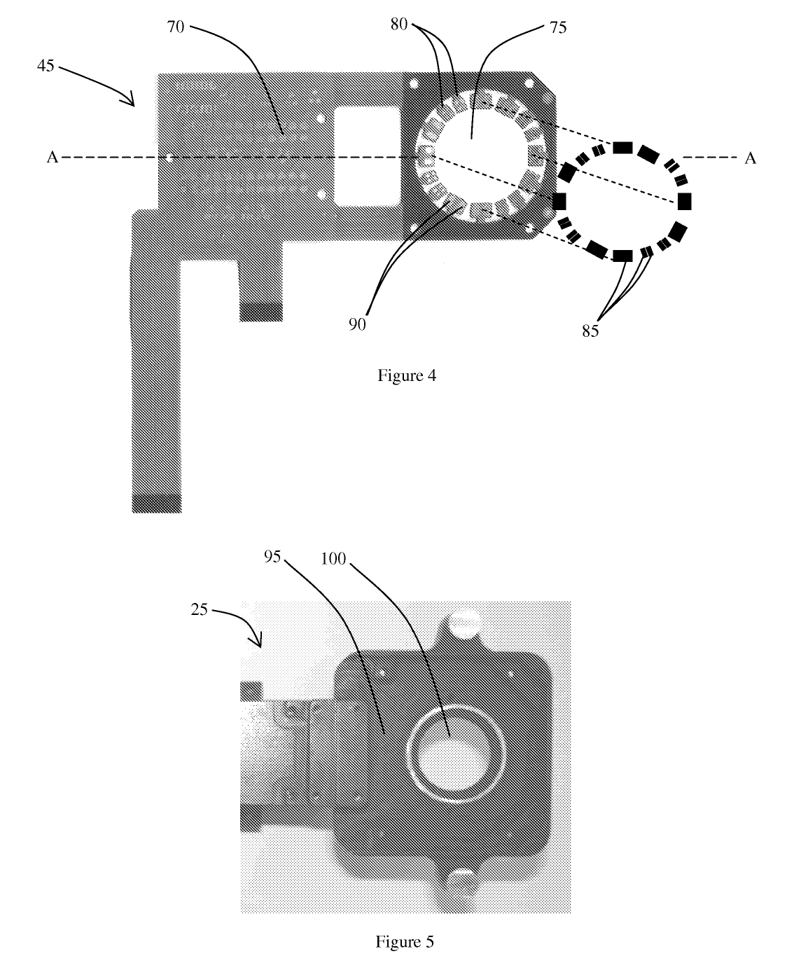

According to various embodiments, the light source 15 may be configured to assume various illumination angles. For example, the light source 15 may generally comprise a substrate 45 having at least one flexible portion (e.g., such as flexible portions 80 shown in FIG. 4). Each flexible portion may have one or more illumination sources, such as light emitting diodes 85 (LED's), mounted thereto. The flexible portion or portions of the substrate 45 may be capable of pivoting to provide different illumination angles and may be secured at a given illumination angle by one or more structural units, such as a holder 35 and a backer 40. According to various embodiments, the light source 15 may further comprise a nose portion 47 and any suitable fastening means (not shown) for retaining the light source 15 in the mounted position upon the chassis 25.

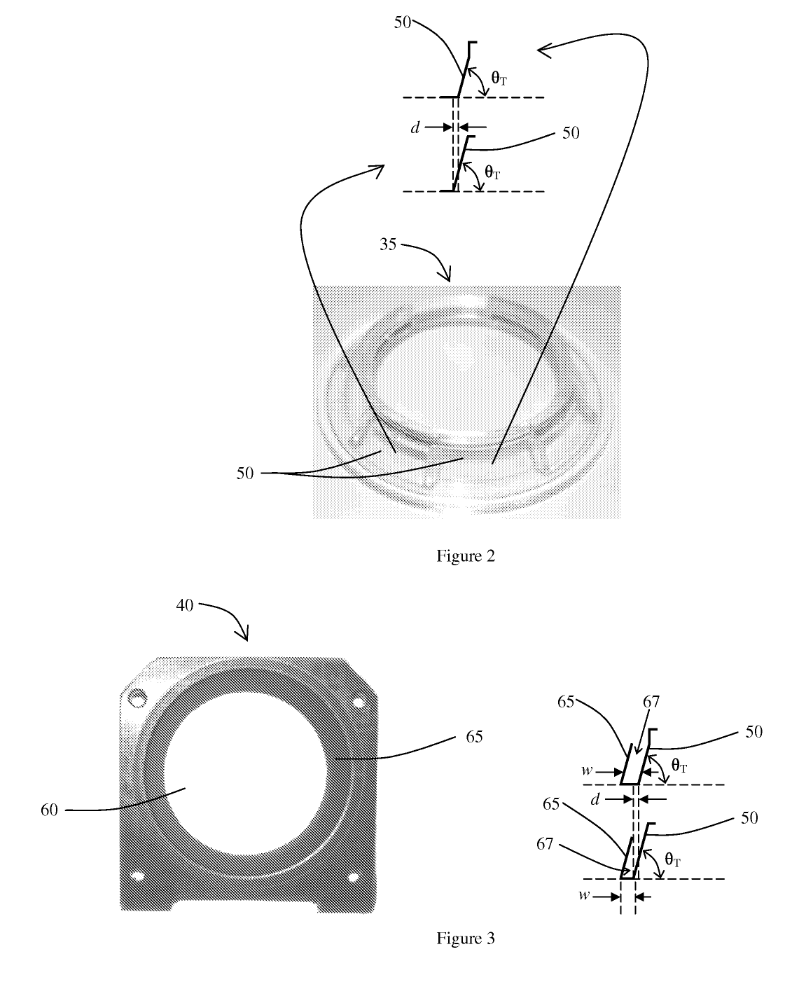

The holder 35 may be positioned between the illumination source and the specimen 30 (e.g., in an illumination path of the illumination source or sources). Also, the holder 35 may be made from any sort of light-transmitting material. FIG. 2 illustrates a top view and cross-sectional views, according to various embodiments, of the holder 35. The holder 35 may track the shape of the flexible portions. For example, in embodiments where the light source 15 is generally ring-shaped, the holder 35 may also be ring-shaped and may exhibit an upwardly-tapered frusto-conical geometry.

According to various embodiments, the holder 35 may comprise one or more shoulder portions 50, with each shoulder portion 50 exhibiting a taper angle θ_{T}. In embodiments comprising more than one shoulder portion 50, the shoulder portions 50 may be arranged in an off-set configuration wherein one or more shoulder portions 50 are shifted inward by a distance d toward a center axis of the holder 35 relative to the other shoulder portions 50. For example, as shown in the embodiments of FIG. 2, the holder 35 may comprise eight shoulder portions 50, with four of the shoulder portions 50 shifted inward toward the center axis by a distance d in an alternating fashion relative to the other four shoulder portions 50. This may be, for example, to accommodate LED's 85 or other illumination sources of differing sizes, for example, as discussed in more detail below.

It will be appreciated that the configuration of FIG. 2 is provided by way of example only, and that other configurations may be employed. In other embodiments, for example, the shoulder portions 50 may not be off-set from one another. In this way, the holder 35 may have a continuous inner surface. In still other embodiments, one or more of the shoulder portions 50 may be shifted inward by a distance different than that of other shifted shoulder portions 50. Additionally, although the taper angles θ_{T} of the shoulder portions 50 in the illustrated embodiments may generally be equal, one or more of the shoulder portions 50 may have a taper angle θ_{T} different from that of other shoulder portions 50.

In addition to securing or contributing to securing the flexible portion or portions of the substrate 45, the holder 35 may perform various other functions in accordance with requirements of the particular application in which the instrument 10 is used. For example, the holder 35 may be fabricated from a diffuse or translucent material, such as an acrylic plastic material. In this way, the holder 35 may serve as a diffuser to the light source 15, controlling its spatial distribution. In addition, the holder 35 may serve as all or a part of a lensing assembly for broadening or narrowing the illumination range of the light source 15. For example, the holder 35 may itself form all or a portion of one or more lenses, or may have one or more lenses embedded therein. In addition, according to various embodiments, the holder 35 may be substantially transparent.

As shown in FIG. 3, the backer 40 may exhibit a planar geometry and define an aperture 60 having an inwardly-tapered seating portion 65 disposed about the periphery thereof. According to various embodiments, the taper angle of the seating portion 65 is equal to, or substantially equal to, the taper angle θ_{T} of the shoulder portions 50. The taper angle θ_{T} may also represent the illumination angle of the light source 15. When the instrument 10 is assembled, the each shoulder portion 50 may be received onto the seating portion 65 such that a gap 67 is defined therebetween. For an inwardly-shifted shoulder portion 50 (see FIG. 2), the corresponding gap 67 exhibits a greater width w than the of non-shifted shoulder portions 50. As discussed below in connection with FIG. 7, the amount d by which a particular shoulder portion 50 is shifted (and thus the width w of the corresponding gap) may be determined based upon the dimensions of components (e.g., LEDs) disposed between holder 35 and the backer 40 when the instrument 10 is assembled.

The backer 40 may generally be fabricated using any suitable plastic or metal material (e.g., Delrin, aluminum). Although the backer 40 is shown as a separate component in the illustrated embodiments, it will be appreciated that in other embodiments the backer 40 may instead be integrally formed as a feature of the chassis 25 (FIG. 5). According to various embodiments, the backer 40 may be formed from a material having good heat-dissipating properties. In this way, the backer 40 may serve as a heat sink for the substrate 45.

The substrate 45 may be fabricated from any material suitable for use in flexible circuit applications, such as, for example, Kapton® Polyimide film available from DuPont, and comprise a circuit pattern 70 formed thereon using conventional circuit printing techniques. Such flexible substrates are commercially available from a number of manufacturers, such as, for example, GC Aero of Torrance, CA. As shown in FIG. 4, the substrate 45 may define an aperture 75 and comprise a plurality of flexible portions 80 extending inwardly toward the center of the aperture 75. One or more of the flexible portions 80 may comprise at least one light-emitting diode 85 (LED) attached thereto via corresponding electrical mounting pads 90. The mounting pads 90 may be integrally formed as a part of the circuit pattern 70. For purposes of clarity, the LEDs 85 are not shown in FIG. 4.

Although the substrate 45 is depicted as comprising sixteen (16) flexible portions 80 arranged in alternating pairs, it will be appreciated by one skilled in the art that the substrate 45 may comprise any number and arrangement of the flexible portions 80. According to various embodiments, the LEDs 85 may be of a surface-mount (SMT) design and configured for attachment using, for example, an IR reflow process. It will be appreciated that the LEDs 85 may emit identical or different frequencies of light (visible and/or non-visible) depending upon factors such as, for example, the particular type of instrument 10 and the application in which it is used. Such factors may also determine the number of LEDs 85 attached to each finger portion 80.

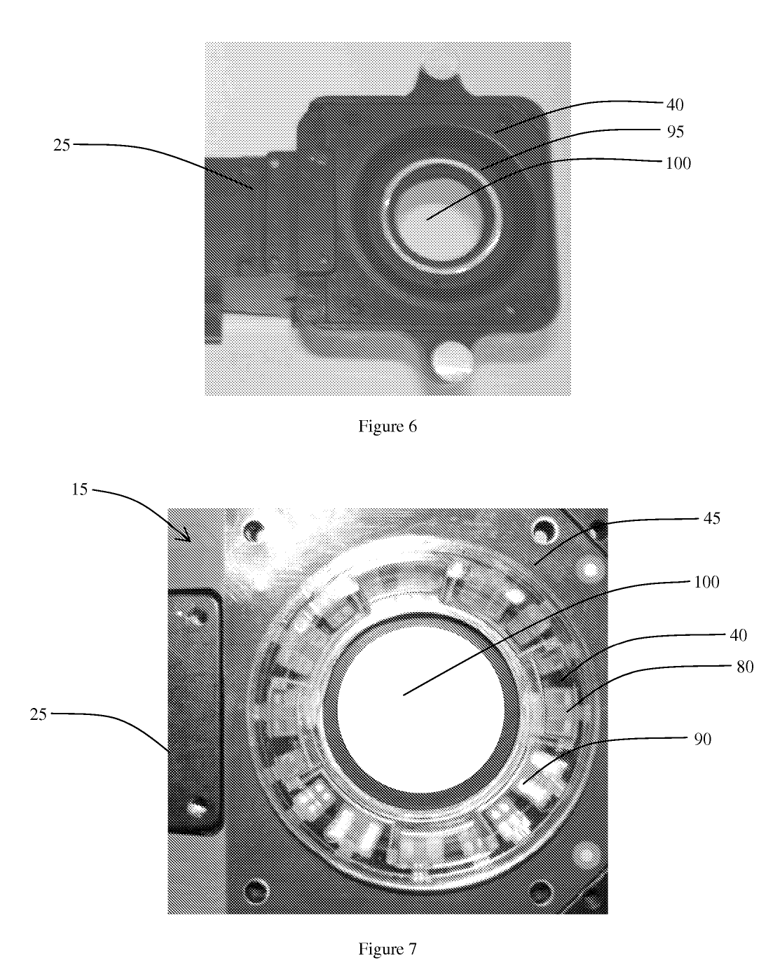

The chassis 25, according to various embodiments, may be fabricated from aluminum or other suitable material and comprise mounting surfaces 95, 100 to which the light source 15 and the sensor assembly 20 are respectively attached. As shown in FIG. 5, the mounting surface 95 may be recessed and suitably contoured such that the backer 40 may be received thereon. Receipt of the backer 40 onto the mounting surface 95 is shown in FIG. 6. The mounting surface 95 may define an aperture 100 through which light reflected from the specimen 30 may be passed to the light sensor assembly 20. It will be appreciated that the chassis 25 may be configured for use with a hand-held instrument 10 or with a machine-operated instrument 10.

FIG. 7 illustrates a bottom view of the chassis 25 having the backer 40, the flexible substrate 45, and the holder 35 installed thereon according to various embodiments. For purposes of clarity, the LEDs 85 and the nose portion 47 are omitted. The flexible substrate 45 is disposed between the holder 35 and the backer 40 such that receipt of the holder 35 onto the backer 40 causes the deflection of the flexible portions 80 relative to a plane (A-A) of the flexible substrate 45. In particular, each finger portion 80 and the LEDs 85 mounted thereon are deflected at an angle determined by the taper angle θ_{T} of the shoulder portions 50 and the backer 40. As shown, the configuration of the substrate 45 and the holder 35 is such that two adjacent flexible portions 80 are deflected by each shoulder portion 80. It will be appreciated, however, that the substrate 45 and the holder 35 may be configured such that more or fewer flexible portions 80 are deflected by each shoulder portion 50. As noted above in connection with FIG. 2, the taper angle θ_{T} of one or more of the shoulder portions 50 may be different from that of other shoulder portions 50. Accordingly, the flexible portions 80 and their corresponding LEDs 85 may be deflected at different angles relative to other flexible portions 80 and their corresponding LEDs 85. Furthermore, because the gap between each shoulder portion 50 and the backer 40 may be varied by shifting the shoulder portion 50 as described above, each flexible portion 80 may accommodate LEDs 85 having dimensions (e.g., height) different from those of other flexible portions 80. Advantageously, the small profile of the light source 15 enables it to be positioned closer to the specimen 30, thus allowing the size of the instrument 10 to be condensed.

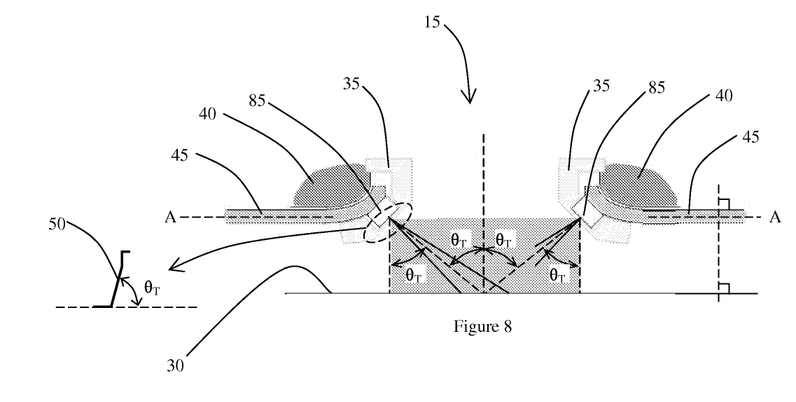

FIG. 8 illustrates the dependence of illumination angle upon the deflection of the flexible portions 80 and their corresponding LEDs 85 according to various embodiments. For a taper angle θ_{T} of the shoulder portions 50 and the seating portion 65, the flexible portions 80 (and thus the optical axis of their corresponding LED 85) are rotated inward by an angle θ_{T} relative to the plane A-A of the flexible substrate 45. Accordingly, where the orientation of the optical instrument 10 is such that the plane A-A of the flexible substrate 45 is generally parallel with the surface of the specimen 30, the emitted light will illuminate the specimen 30 at an angle θ_{T.} Accordingly, the angle by which emitted light illuminates the specimen 30 is determined by the deflection angle of the substrate 45 relative to the specimen 30, which is, as shown, determined by the taper angle θ_{T} of the holder 35 and the backer 40.

According to various embodiments, the deflection of the flexible portions 80 may be determined in various other ways. For example, the holder 35 may be omitted. In this case, the flexible portions 80 may be secured to the backer 40, or the seating portion 65 by any suitable method including, for example, glue, adhesive, etc. According to various embodiments, the flexible portions 80 may be secured to the backer 40 by mechanical means. For example, a frame may extend from the backer 40 to secure the flexible portions 80. Alternatively, other mechanical devices may be used including, for example, clips, hooks, slots in the backer 40, etc. Also, according to various embodiments, the backer 40 may be omitted and the flexible portions 80 of the substrate 45 may be secured to the holder 35, for example, using any of the means described above.

It will be appreciated that the illumination angle of light emitted from the light source 15 is easily varied by suitably modifying the taper angle θ_{T} of the shoulder portions 50 and the seating portion 65. The ability to vary the illumination angle in this fashion is particularly advantageous during design and development phases of the instrument 10. In particular, because the holder 35 and the backer 40 may be quickly interchanged or modified to provide the desired taper angle θ_{T,} the time and expense required for development iterations (e.g., prototyping and testing) is substantially reduced. Additionally, because only minimal component modifications are necessary for adapting the light source 15 for use in a variety of instruments 10 having different illumination angle requirements, design and manufacturing costs are significantly reduced. Design and manufacturing costs are further reduced by the use of conventional components (e.g., flex circuit material, SMT LEDs) and conventional circuit population techniques for light source 15 fabrication.

Although the embodiments shown illustrate the light source 15 as ring-shaped, it will be appreciated that the general principles disclosed herein may be applicable to non-ring-shaped light sources also. For example, one or more flexible portions may be arranged linearly, forming a line-shaped light source 15. The lineary flexible portion or portions may be deflected, for example, as described above.

It will be appreciated by one skilled in the art that uses of the light source 15 are not limited to the above-described instrumentation. In particular, it will be appreciated that the light source 15 may be suitably adapted for use in any lighting application in which it is desirable to adjust the illumination angle quickly and with minimal expense. Such applications may include not only instrumentation-related lighting applications, but also general lighting applications (e.g., residential, commercial, or industrial lighting applications).

Whereas particular embodiments of the invention have been described herein for the purpose of illustrating the invention and not for the purpose of limiting the same, it will be appreciated by those of ordinary skill in the art that numerous variations of the details, materials, configurations and arrangement of components may be made within the principle and scope of the invention without departing from the spirit of the invention. The preceding description, therefore, is not meant to limit the scope of the invention.

We claim:

1. A light source comprising:
a substrate comprising at least one flexible portion;
an illumination source mounted on the flexible portion;
a structural unit positioned relative to the flexible portion to determine a deflection angle of the flexible portion; and
wherein an illumination angle of the light source is dependent on the deflection angle of the flexible portion.

2. The light source of claim 1, wherein the structural unit is a holder positioned in an illumination path of the illumination source.

3. The light source of claim 2, wherein the holder comprises at least one lens.

4. The light source of claim 2, wherein the holder comprises a diffuse material.

5. The light source of claim 2, wherein the holder is transparent.

6. The light source of claim 2, wherein the holder comprises a first shoulder portion and a second shoulder portion, wherein the first shoulder portion is positioned in an illumination path of the illumination source, and the second shoulder portion is positioned in an illumination path of a second illumination source.

7. The light source of claim 1, wherein the structural unit is a backer positioned outside of an illumination path of the illumination source.

8. The light source of claim 7, wherein the backer comprises a heat-dissipating material.

9. The light source of claim 7, wherein the backer comprises a frame positioned relative to the flexible portion to determine the deflection angle of the flexible portion.

10. The light source of claim 1, wherein the substrate comprises a plurality of flexible portions.

11. The light source of claim 10, wherein the plurality of flexible portions are arranged in a ring.

12. The light source of claim 10, wherein the plurality of flexible portions are arranged in a line.

13. The light source of claim 1, further comprising a second illumination source mounted on the flexible portion.

14. The light source of claim 1, further comprising a second structural unit positioned to determine the deflection angle of the flexible portion, wherein the structural unit is positioned on a first side of the substrate and the second structural unit is positioned on a second side of the substrate.

15. The light source of claim 1, wherein the flexible portion is secured to the structural unit with adhesive.

16. The light source of claim 1, wherein the flexible portion is secured to the structural unit with at least one of a clip and a hook.

17. An instrument comprising a light source, the light source comprising:
a substrate comprising at least one flexible portion;
an illumination source mounted on the flexible portion;
a structural unit positioned relative to the flexible portion to determine a deflection angle of the flexible portion; and
wherein an illumination angle of the light source is dependent on the deflection angle of the flexible portion.

18. A light source comprising:
a substrate comprising at least one flexible portion;
an illumination source mounted to the flexible portion;
a holder positioned in an illumination path of the illumination source;
a backer; and
wherein the at least one flexible portion is positioned between the backer and the holder, wherein a deflection angle of the flexible portion is determined by a taper angle of at least one of the backer and the holder, and wherein an illumination angle of the light source is dependent on the deflection angle.

19. The light source of claim 18, wherein the holder comprises at least one lens.

20. The light source of claim 18, wherein the holder comprises a diffuse material.

21. The light source of claim 18, wherein the holder is transparent.

22. The light source of claim 18, wherein the holder comprises a first shoulder portion and a second shoulder portion, wherein the first shoulder portion is positioned in an illumination path of a first of the at least one illumination source, and the second shoulder portion is positioned in an illumination path of a second of the at least one illumination source.

23. The light source of claim 18, wherein the backer comprises a heat-dissipating material.

24. In a light source comprising a substrate comprising at least one flexible portion;
an illumination source mounted on the flexible portion; a structural unit positioned relative to the flexible portion to deflect the flexible portion at a first deflection angle; wherein an illumination angle of the light source is dependent on the deflection angle of the flexible portion, a method, the method comprising:
removing the structural unit;
replacing the structural unit with a second structural unit positioned relative to the flexible portion to deflect the flexible portion by a second deflection angle.
